(19) United States
(12) Patent Application Publication
(10) Pub. No.: US 2026/0060301 A1
(43) Pub. Date: Mar. 5, 2026

(54) AEROSOL-GENERATING DEVICE AND CARTRIDGE

(71) Applicant: KT&G CORPORATION, Daejeon (KR)

(72) Inventor: Chul Ho JANG, Gyeonggi-do (KR)

(73) Assignee: KT&G CORPORATION, Daejeon (KR)

(21) Appl. No.: 19/290,798

(22) Filed: Aug. 5, 2025

(30) Foreign Application Priority Data
Aug. 27, 2024 (KR) 10-2024-0115242

(51) Int. Cl. A24F 40/44; A24F 40/10; A24F 40/42; A24F 40/46; A24F 40/48; H05B 3/20

(52) U.S. Cl. CPC A24F 40/44; A24F 40/10; A24F 40/42; A24F 40/46; A24F 40/48; H05B 3/20; H05B 2203/021

(57) ABSTRACT

An aerosol-generating device is disclosed. An aerosol-generating device according to an embodiment of the present invention may include: a housing; a chamber including an aerosol-generating material; a liquid delivery means configured to deliver the aerosol-generating material in an area adjacent to the chamber, wherein at least a part of the liquid delivery means is recessed therein; and a heating element that heats the aerosol-generating material to generate an aerosol, wherein at least a part of the heating element may be located in at least a part of a recessed area of the liquid delivery means.

### CROSS-REFERENCE TO RELATED APPLICATION

This application claims priority to Korean Patent Application No. 10-2024-0115242, filed on Aug. 27, 2024, the disclosure of which is incorporated herein by reference in its entirety.

### FIELD OF TECHNOLOGY

Various embodiments of the present invention relate to an aerosol-generating device having a liquid delivery means and a cartridge for the aerosol-generating device.

### BACKGROUND

An aerosol-generating device, typically including a cartridge, is configured such that a liquid aerosol-generating material stored in the cartridge chamber is delivered to a liquid delivery means, such as a wick, and the liquid delivery means is heated by a heater to generate an aerosol.

As the aerosol-generating material impregnated in such a liquid delivery means is heated, bubbles are generated at the surface of the liquid delivery means, and a spitback phenomenon occurs in which the liquid covering the bubbles splashes in the form of droplets due to the rise of the bubbles.

This spitback phenomenon may result in a liquid overflow phenomenon where liquid leaks out of the cartridge, which may cause liquid to leak from the device or cause an unpleasant taste to the user when inhaling the aerosol.

### SUMMARY

The technical problem to be achieved by the present invention is to solve the above-mentioned problem and to provide an aerosol-generating device, a cartridge and a heater module including a liquid delivery means formed such that at least a part of a space is recessed therein.

The problems to be solved by the present invention are not limited to the problems mentioned above, and other problems not mentioned will be clearly understood by a person skilled in the art from the following description.

According to one or more example implementations of the present disclosure, an aerosol-generating device may include: a housing; a chamber including an aerosol-generating material; a liquid delivery means configured to deliver the aerosol-generating material in an area adjacent to the chamber, wherein at least a part of the liquid delivery means is recessed therein; and a heating element that heats the aerosol-generating material to generate an aerosol, wherein at least a part of the heating element may be located in at least a part of a recessed area of the liquid delivery means.

A cartridge according to an embodiment of the invention is detachable from an aerosol-generating device, including: a chamber including an aerosol-generating material; a liquid delivery means configured to deliver the aerosol-generating material in an area adjacent to the chamber, wherein at least a part of the liquid delivery means is recessed therein; and a heating element that heats the aerosol-generating material to generate an aerosol, wherein at least a part of the heating element may be located in at least a part of a recessed area of the liquid delivery means.

A heater module according to an embodiment of the present invention is a heater module that is detachable from an aerosol-generating device or a cartridge, including: a liquid delivery means configured to absorb an aerosol-generating material, wherein at least a part of the liquid delivery means is recessed therein; and a heating element that heats the aerosol-generating material to generate an aerosol, wherein at least a part of the heating element may be located in at least a part of a recessed area of the liquid delivery means.

According to an embodiment of the present invention, a liquid delivery means is provided which is formed such that at least a part of the space is recessed therein, whereby the occurrence of spitback phenomenon may be minimized.

The effects of the present invention are not limited to the effects mentioned above, and other effects not mentioned will be clearly understood by a person skilled in the art from the following description.

### BRIEF DESCRIPTION OF THE DRAWINGS

FIG. 1 is a block diagram of an aerosol-generating device according to an embodiment.

FIG. 2 shows an aerosol-generating device according to an embodiment.

FIG. 3 is an illustrative diagram showing a spitback phenomenon of an aerosol-generating device.

FIGS. 4A-4C are exemplary views illustrating a liquid delivery means and a heating element according to various embodiments.

FIG. 5 illustrates a partial area of a cartridge according to an embodiment.

FIG. 6 illustrates a partial area of a cartridge according to another embodiment.

FIGS. 7A-7E illustrate a heating element according to various embodiments.

FIGS. 8A-8E illustrate cross-sections of a heating element according to various embodiments.

### DETAILED DESCRIPTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes “module” and “unit” are used only in consideration of facilitation of description, and do not have mutually distinguished meanings or functions. As used herein, the suffix “module” or “unit” may include a unit implemented in hardware, software, or firmware, and may be used interchangeably with other terms, for example, “logic,” “logic block,” “part,” or “circuitry. ” A “module” or a “unit” may be a single integral component, or a minimum unit or part thereof, adapted to perform one or more functions. For example, the “module” or the “unit” may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and spirit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to”another component, there are no intervening components present.

As used herein, the singular form is intended to include the plural forms as well, unless the context clearly indicates otherwise.

Embodiments as set forth herein may be implemented as software including one or more instructions that are stored in a storage medium (e.g., a memory 17) that is readable by a machine (e.g., the aerosol-generating device 1). For example, a processor (e.g., the controller 12) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

In the present disclosure, the directions of the aerosol-generating device 1 may be defined based on the orthogonal coordinate system. In the orthogonal coordinate system, the x-axis direction may be defined as a leftward-rightward direction of the aerosol-generating device 1. The y-axis direction may be defined as a forward-backward direction of the aerosol-generating device 1. The z-axis direction may be defined as an upward-downward direction of the aerosol-generating device 1.

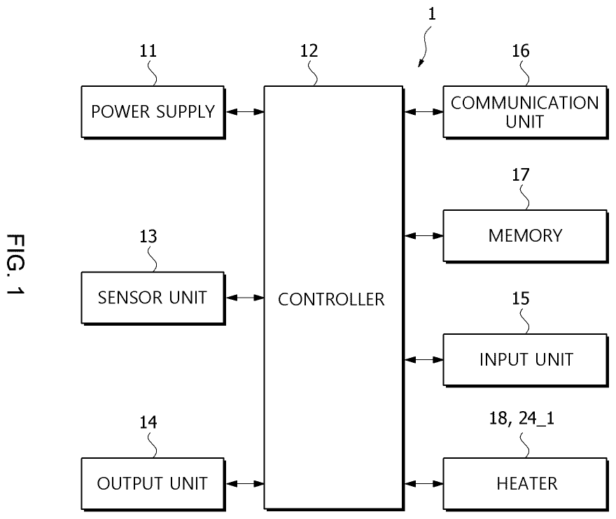

FIG. 1 is a block diagram of an aerosol-generating device according to an embodiment.

According to one embodiment, the aerosol-generating device 1 may include a power supply 11, a controller 12, a sensor unit 13, an output unit 14, an input unit 15, a communication unit 16, a memory 17, and/or a heater 18 and 24. However, the components included in the aerosol-generating device 1 are not limited to those shown in FIG. 1. That is, it will be understood by those skilled in the art related to the present embodiment that some of the components shown in FIG. 1 may be omitted or new components may be further included depending on the design of the aerosol-generating device 1.

According to one embodiment, the sensor unit 13 may detect the state of the aerosol-generating device 1 or the state of the surroundings of the aerosol-generating device 1, and may transmit the detected information to the controller 12. For example, the sensor unit 13 may include a temperature sensor, a puff sensor, an insertion detection sensor, a reuse detection sensor, an overly moist state detection sensor, a cigarette identification sensor, a cartridge detection sensor, a cap detection sensor, and/or a movement detection sensor. Meanwhile, the sensor unit 13 may further include various sensors, such as a liquid residual quantity sensor for detecting the residual quantity of liquid in the cartridge and an immersion sensor for detecting immersion of the aerosol-generating device 1.

According to one embodiment, the temperature sensor may detect a temperature to which the heater 18 and 24 is heated. The aerosol-generating device 1 may include a separate temperature sensor for detecting the temperature of the heater 18 and 24, or the heater 18 and 24 itself may serve as a temperature sensor. In an example, the temperature sensor may be used to measure impedance for the heater 18. The impedance for the heater 18 may correlate with the temperature of the heater 18. The temperature sensor may measure current and/or voltage applied to the heater 18 (or an induction coil). The impedance for the heater 18 may be obtained based on the measured current and/or voltage. The controller 12 may estimate the temperature of the heater 18 based on the obtained impedance.

In an example, the temperature sensor may include a resistance element (e.g., a thermistor), the resistance value of which varies in response to changes in the temperature of the heater 18 and 24. The temperature sensor may output a signal corresponding to the resistance value of the resistance element, and the controller 12 may determine the temperature of the heater 18 and 24 and/or a change in the temperature of the heater 18 and 24 based on the signal corresponding to the resistance value.

In another example, the temperature sensor may include a sensor that detects the resistance value of the heater 18 and 24. The temperature sensor may output a signal corresponding to the resistance value of the heater 18 and 24, and the controller 12 may determine the temperature of the heater 18 and 24 and/or a change in the temperature of the heater 18 and 24 based on the signal corresponding to the resistance value.

According to one embodiment, the temperature sensor may detect the temperature of the power supply 11. The temperature sensor may be disposed adjacent to the power supply 11. For example, the temperature sensor may be attached to one surface of the power supply 11 (e.g., a battery) and/or may be mounted on one surface of a printed circuit board. In an example, the aerosol-generating device 1 may include a power supply protection circuit module (PCM), and the temperature sensor may be disposed adjacent to the power supply 11 together with the power supply protection circuit module.

According to one embodiment, the temperature sensor may be disposed in a housing (not shown) of the aerosol-generating device 1 to detect the internal temperature of the housing (not shown).

According to one embodiment, the puff sensor may detect a user's puff.

In an example, the puff sensor may include a pressure sensor. The pressure sensor may output a signal corresponding to the internal pressure of the aerosol-generating device 1, and the controller 12 may determine the user's puff based on the signal corresponding to the internal pressure. Here, the internal pressure of the aerosol-generating device 1 may correspond to the pressure of an airflow path through which gas flows. The puff sensor may be disposed corresponding to the airflow path through which gas flows in the aerosol-generating device 1.

In another example, the puff sensor may include a temperature sensor. When the user's puff occurs, temperature drop may temporarily occur in the airflow path, a space into which an aerosol-generating article is inserted (hereinafter referred to as an “insertion space”), and the heater 18 and 24. The controller 12 may determine the user's puff based on a signal corresponding to the temperature of the airflow path output from the temperature sensor.

In still another example, the puff sensor may include both a pressure sensor and a temperature sensor. In this case, the temperature sensor may measure temperature used to calibrate the internal pressure measured by the pressure sensor. In one example, the puff sensor may calibrate a signal corresponding to the internal pressure based on the temperature measured by the temperature sensor, and may output the calibrated signal. In another example, the puff sensor may output a signal corresponding to the temperature measured by the temperature sensor and a signal corresponding to the internal pressure measured by the puff sensor. In this case, the controller 12 may receive the signals, and may calibrate the signal corresponding to the internal pressure based on the signal corresponding to the temperature.

In still another example, the puff sensor may include a capacitance sensor. The capacitance sensor may also be called a cap sensor or a capacitive sensor. When the user's puff occurs, a temperature change and/or aerosol flow may occur in the insertion space of the aerosol-generating article, and accordingly, a dielectric constant in the insertion space may change. The controller 12 may determine the user's puff based on a signal corresponding to the dielectric constant in the insertion space output from the capacitance sensor.

The puff sensor is not limited to the examples described above, and may be implemented as various sensors for detecting the user's puff.

According to one embodiment, the insertion detection sensor may detect insertion and/or removal of the aerosol-generating article. The insertion detection sensor may be mounted adjacent to the insertion space. In addition, the insertion detection sensor may include any combination of the examples described above.

In an example, the insertion detection sensor may include a capacitance sensor. The capacitance sensor may include at least one conductor, and the at least one conductor may be disposed adjacent to the insertion space. When the aerosol-generating article is inserted into or removed from the insertion space, capacitance around the conductor may change. The controller 12 may determine insertion and/or removal of the aerosol-generating article based on a signal corresponding to the dielectric constant in the insertion space output from the capacitance sensor.

In another example, the insertion detection sensor may include an inductive sensor. The inductive sensor may include at least one coil, and the at least one coil may be disposed adjacent to the insertion space. If the aerosol-generating article (e.g., a wrapper of the aerosol-generating article) includes a conductor, when the aerosol-generating article is inserted into or removed from the insertion space, a change in magnetic field may occur around the coil through which current flows. The controller 12 may determine insertion and/or removal of the aerosol-generating article including a conductor based on the characteristics of the current output from or detected by the inductive sensor (e.g., frequency of alternating current, a current value, a voltage value, an inductance value, and an impedance value). Alternatively, a susceptor SUS or the like may be included in the aerosol-generating article (e.g., a medium portion of the aerosol-generating article). In this case, a change in magnetic field may also occur around the coil based on insertion or removal of the susceptor or the like into or from the insertion space, and the controller 12 may determine insertion and/or removal of the aerosol-generating article based on the characteristics of the current of the inductive sensor.

The insertion detection sensor is not limited to the examples described above, and may be implemented as various sensors (e.g., a proximity sensor) for detecting insertion and/or removal of the aerosol-generating article. In addition, the insertion detection sensor may include any combination of the examples described above. According to one embodiment, the insertion detection sensor may include a switch or the like for detecting pressing by the aerosol-generating article.

According to one embodiment, the reuse detection sensor may detect whether the aerosol-generating article is being reused. In an example, the reuse detection sensor may be a color sensor for detecting the color of the aerosol-generating article. If the aerosol-generating article is used by the user, a change in the color of a portion of the wrapper may occur due to the generated aerosol or heating. The color sensor may output a signal corresponding to an optical characteristic (e.g., wavelength of light) corresponding to the color of the wrapper based on the light reflected from the wrapper. When a change in the color of a portion of the wrapper is detected, the controller 12 may determine that the aerosol-generating article inserted into the insertion space has already been used.

According to one embodiment, the overly moist state detection sensor may detect whether the aerosol-generating article is in an overly moist state. For example, the overly moist state detection sensor may include a capacitance sensor. The capacitance sensor may include at least one conductor disposed adjacent to the insertion space. The controller 12 may determine whether the aerosol-generating article is in an overly moist state based on the level of a signal corresponding to the dielectric constant or the like output from the capacitance sensor. In an example, the controller 12 may check a level range within which the level of the signal is included based on a look-up table, and may determine the moisture content of the aerosol-generating article based on the checked level range.

According to one embodiment, the cigarette identification sensor may detect whether the aerosol-generating article is authentic and/or may detect the type of the aerosol-generating article.

In an example, the cigarette identification sensor may include an optical sensor for detecting an identification material (or an identification mark) located on the outer surface (e.g., the wrapper) of the aerosol-generating article. The optical sensor may radiate light toward the identification material (or the identification mark) of the aerosol-generating article, and may detect whether the aerosol-generating article is authentic and/or may detect the type of the aerosol-generating article based on the reflected light. For example, the identification material may include a material (i.e., a luminous material) that emits light of a specific wavelength band based on the light radiated thereto. The controller 12 may determine whether the aerosol-generating article is authentic and/or may determine the type of the aerosol-generating article based on the range of the wavelength.

In another example, the cigarette identification sensor may include a capacitance sensor. The dielectric constant in the insertion space may vary depending on the type of the aerosol-generating article inserted into the insertion space. The controller 12 may determine whether the aerosol-generating article is authentic and/or may determine the type of the aerosol-generating article based on a signal corresponding to the dielectric constant or the like in the insertion space output from the capacitance sensor.

In still another example, the cigarette identification sensor may include an inductive sensor. If a conductor is included in the wrapper and/or inner portion (e.g., the medium portion) of the aerosol-generating article inserted into the insertion space, when the aerosol-generating article is inserted into the insertion space, the characteristics of the current detected by the inductive sensor (e.g., frequency of alternating current, a current value, a voltage value, an inductance value, and an impedance value) may vary depending on the type of the aerosol-generating article inserted into the insertion space. The controller 12 may determine whether the inserted aerosol-generating article is authentic and/or may determine the type of the inserted aerosol-generating article based on the characteristics of the current output from or detected by the inductive sensor.

The cigarette identification sensor is not limited to the examples described above, and may be implemented as various sensors for detecting whether the aerosol-generating article is authentic and/or detecting the type of the aerosol-generating article. In addition, the cigarette identification sensor may include any combination of the examples described above.

According to one embodiment, the cartridge detection sensor may detect mounting and/or removal of the cartridge. For example, the cartridge detection sensor may include an inductive sensor, a capacitance sensor, a resistance sensor, a Hall sensor (Hall IC), and/or an optical sensor.

According to one embodiment, the cap detection sensor may detect mounting and/or removal of the cap. For example, the cap detection sensor may include an inductive sensor, a capacitance sensor, a resistance sensor, a contact sensor, a Hall sensor (Hall IC), and/or an optical sensor. The cap may cover at least a portion of the cartridge mounted in or inserted into the aerosol-generating device 1 or may cover at least a portion of the housing of the aerosol-generating device 1. When the cap is mounted in or removed from the housing, the cap detection sensor may output a signal corresponding to mounting or removal, and the controller 12 may determine mounting or removal of the cap based on the signal corresponding to mounting or removal.

According to one embodiment, the movement detection sensor may detect movement of the aerosol-generating device 1. The movement detection sensor may be implemented as at least one of an acceleration sensor or a gyro sensor.

According to one embodiment, the sensor unit 13 may further include at least one of a humidity sensor, an air pressure sensor, a magnetic sensor, a position sensor (global positioning system (GPS)), or a proximity sensor in addition to the sensors described above. The functions of the sensors can be intuitively deduced by those skilled in the art from the names thereof, and thus detailed descriptions thereof may be omitted.

According to one embodiment, the output unit 14 may output information about the state of the aerosol-generating device 1 to provide the same to the user. The output unit 14 may include, but is not limited to, a display, a haptic unit, and/or a sound output unit. For example, information about the aerosol-generating device 1 may include a charging/discharging state of the power supply 11 of the aerosol-generating device 1, a preheating state of the heater 18 and 24, an insertion/removal state of the aerosol-generating article and/or the cartridge, a mounting/removal state of the cap, or a state in which the use of the aerosol-generating device 1 is restricted (e.g., detection of an abnormal object). The display may visually provide the information about the state of the aerosol-generating device 1 to the user. For example, the display may include a light-emitting diode (LED), a liquid crystal display panel (LCD), and an organic light-emitting diode panel (OLED). If the display includes a touchpad, the display may also be used as the input unit 15. The haptic unit may haptically provide the information about the aerosol-generating device 1 to the user. For example, the haptic unit may include a vibration motor, a piezoelectric element, and an electrical stimulation device. The sound output unit may audibly provide the information about the aerosol-generating device 1 to the user. For example, the sound output unit may convert an electrical signal into an acoustic signal and may output the acoustic signal to the outside.

According to one embodiment, the power supply 11 may supply power used for operation of the aerosol-generating device 1. The power supply 11 may include one or more batteries. The power supply 11 may supply power so that the heater 18 and 24 is heated. In addition, the power supply 11 may supply power necessary for operation of the other components included in the aerosol-generating device 1, such as the controller 12, the sensor unit 13, the output unit 14, the input unit 15, the communication unit 16, and the memory 17. The power supply 11 may be a rechargeable battery or a disposable battery. For example, the power supply 11 may be a lithium polymer (LiPoly) battery without being limited thereto. The power supply 11 may be a replaceable (separation-type) battery (hereinafter referred to as a “removable battery”). The removable battery may be mounted in a battery accommodation portion provided in the aerosol-generating device 1 or may be removed from the battery accommodation portion. The removable battery may be charged in a wired and/or wireless manner.

According to one embodiment, the heater 18 and 24 may receive power from the power supply 11 to heat the aerosol-generating article (e.g., a cigarette) and/or a medium and/or an aerosol-generating substance in the cartridge. The aerosol-generating device 1 may include a heater 18 for heating the aerosol-generating article and/or a cartridge heater 24 for heating the cartridge (i.e., a solid and/or liquid medium).

According to one embodiment, the heater 18 and 24 may be an electro-resistive heater. For example, the electro-resistive heater may include an electrically resistive material such as a metal or a metal alloy including titanium, zirconium, tantalum, platinum, nickel, cobalt, chromium, hafnium, niobium, molybdenum, tungsten, tin, gallium, manganese, iron, copper, stainless steel, and nichrome. The electro-resistive heater may be implemented as a metal wire, a metal plate having an electrically conductive track disposed thereon, or a ceramic heating element.

According to one embodiment, the heater 18 and 24 may be an induction heater. For example, the induction heater may include a susceptor that generates heat through a magnetic field. A magnetic field may be generated by an induction coil by alternating current flowing through the induction coil. The magnetic field may pass through the heater, and an eddy current may be generated in the susceptor. The susceptor may be heated based on generation of the eddy current. According to one embodiment, the susceptor may be included in the inner portion (e.g., the medium portion) of the aerosol-generating article. In this case, the susceptor included in the inner portion of the aerosol-generating article may also be heated by the induction coil.

The heater 18 and 24 is not limited to the examples described above, and may include or be replaced with various heating methods, structures, and components for heating the aerosol-generating article and/or the cartridge.

According to one embodiment, the input unit 15 may receive information input from the user. For example, the input unit 15 may include a touch panel, a button, a keypad, a dome switch, a jog wheel, and a jog switch.

According to one embodiment, the memory 17 may be hardware storing various pieces of data processed in the aerosol-generating device 1. The memory 17 may store data processed and to be processed by the controller 12. For example, the memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. For example, the memory 17 may store data on an operation time of the aerosol-generating device 1, the maximum number of puffs, the current number of puffs, at least one temperature profile, and the user's smoking pattern.

According to one embodiment, the communication unit 16 may include at least one component for communication with other electronic devices (e.g., a portable electronic device). For example, the communication unit 16 may include a Bluetooth communication unit, a Bluetooth low energy (BLE) communication unit, a near-field communication unit, a wireless local area network (WLAN) communication unit, a Zigbee communication unit, an infrared data association (IrDA) communication unit, a Wi-Fi direct (WFD) communication unit, an ultra-wideband (UWB) communication unit, an Ant+ communication unit, a cellular network communication unit, an Internet communication unit, and a computer network (e.g., LAN or WAN) communication unit.

According to one embodiment, the controller 12 may control the overall operation of the aerosol-generating device 1. For example, the controller 12 may include at least one processor. The controller 12 may be implemented as an array of a plurality of logic gates or may be implemented as a combination of a general-purpose microcontroller unit (MCU) (or a microprocessor) and a memory in which a program executable by the MCU is stored. It will be understood by those skilled in the art that the controller may also be implemented as other forms of hardware.

According to one embodiment, the controller 12 may control the supply of power from the power supply 11 to the heater 18 and 24 to control the temperature of the heater 18 and 24. The controller 12 may control the temperature of the heater 18 and 24 and/or power supplied to the heater 18 and 24 based on the temperature of the heater 18 and 24 detected by the temperature sensor (e.g., the sensor unit 13). The controller 12 may control the temperature of the heater 18 and 24 and/or power supplied to the heater 18 and 24 based on the temperature profile and/or the power profile stored in the memory 17.

According to one embodiment, the controller 12 may control a power conversion circuit (not shown) electrically connected to the heater 18 and 24 and the power supply 11 to control power (e.g., voltage and/or current) supplied to the heater 18 and 24. For example, the power conversion circuit may include a DC/DC converter (e.g., a buck converter, a buck-boost converter, a boost converter, or a Zener diode) that converts power to be supplied to the heater 18 and 24 and a DC/AC converter (e.g., an inverter) that converts power to be supplied to the induction coil (not shown). The DC/AC converter may be implemented as a full-bridge circuit or a half-bridge circuit including a plurality of switching elements. For example, the power conversion circuit may include at least one switching element, such as a bipolar junction transistor (BJT) or a field effect transistor (FET).

According to one embodiment, the controller 12 may control the frequency and/or duty ratio of a current pulse input to at least one switching element of the power conversion circuit (not shown) to control the current and/or the voltage supplied to the heater 18 and 24. The duty ratio for the on/off operation of the switching element may correspond to a ratio of the voltage output from the power conversion circuit to the voltage output from the power supply 11.

According to one embodiment, the controller 12 may control power supplied to the heater 18 and 24 using at least one of a pulse width modulation (PWM) scheme or a proportional-integral-differential (PID) scheme. For example, the controller 12 may perform control using the PWM scheme such that a current pulse having a predetermined frequency and a predetermined duty ratio is supplied to the heater 18 and 24. The controller 12 may control the frequency and duty ratio of the current pulse to control power supplied to the heater 18 and 24. For example, the controller 12 may determine, based on the temperature profile, a target temperature to be controlled. The controller 12 may control power supplied to the heater 18 and 24 using the PID scheme, which is a feedback control scheme using a difference value between the temperature of the heater 18 and the target temperature, a value obtained by integrating the difference value with respect to time, and a value obtained by differentiating the difference value with respect to time.

According to one embodiment, the controller 12 may determine, based on the power profile, target power to be controlled. The controller 12 may control power supplied to the heater 18 and 24 so as to correspond to the preset target power over time.

According to one embodiment, the controller 12 may detect power supplied to the heater 18 and 24 to determine the user's puff. In more detail, the controller 12 may control power supplied to the heater 18 and 24 using the proportional-integral-differential (PID) scheme. When the user's puff occurs, temperature drop may temporarily occur in a space into which the aerosol-generating article is inserted (hereinafter referred to as an insertion space) and the heater 18 and 24. Accordingly, the power (or the current) supplied to the heater 18 and 24 may change during control of the power using the PID scheme. The controller 12 may determine the user's puff based on the change in the power controlled.

According to one embodiment, the controller 12 may prevent the heater 18 and 24 from overheating. For example, the controller 12 may control, based on the temperature of the heater 18 and 24 exceeding a preset limit temperature, operation of the power conversion circuit such that the amount of power supplied to the heater 18 and 24 is reduced or the supply of power to the heater 18 and 24 is interrupted.

According to one embodiment, the controller 12 may control charging/discharging of the power supply 11. For example, the controller 12 may check the temperature of the power supply 11 using the temperature sensor (e.g., the sensor unit 13). If the temperature of the power supply 11 is equal to or higher than a first limit temperature, the controller 12 may interrupt charging of the power supply 11. If the temperature of the power supply 11 is equal to or higher than a second limit temperature, the controller 12 may interrupt use of the power stored in the power supply 11 (e.g., discharging). The controller 12 may calculate the remaining amount of the power stored in the power supply 11. For example, the controller 12 may calculate the remaining capacity of the power supply 11 based on a voltage and/or current detection value of the power supply 11.

According to one embodiment, the controller 12 may control the supply of power to the heater 18 and 24 based on a result of the detection by the sensor unit 13.

According to one embodiment, the controller 12 may control the supply of power to the heater 18 and 24 based on insertion and/or removal of the aerosol-generating article into and/or from the insertion space. For example, upon determining that the aerosol-generating article has been inserted into the insertion space using the insertion detection sensor (e.g., the sensor unit 13), the controller 12 may perform control such that power is supplied to the heater 18 and 24. Upon determining that the aerosol-generating article has been removed from the insertion space using the insertion detection sensor (e.g., the sensor unit 13), the controller 12 may interrupt the supply of power to the heater 18 and 24. The controller 12 may determine that the aerosol-generating article has been removed from the insertion space when the temperature of the heater 18 and 24 is equal to or higher than a limit temperature or when the temperature change slope of the heater 18 and 24 is equal to or greater than a preset slope.

According to one embodiment, the controller 12 may control, based on the state of the aerosol-generating article, a power supply time and/or the amount of power supplied to the heater 18 and 24. For example, upon determining that the aerosol-generating article is in an overly moist state using the overly moist state detection sensor (e.g., the sensor unit 13), the controller 12 may increase a time during which power is supplied to the heater 18 and 24 (e.g., a preheating time).

According to one embodiment, the controller 12 may control the supply of power to the heater 18 and 24 based on whether the aerosol-generating article is being reused. For example, upon determining that the aerosol-generating article has already been used, the controller 12 may interrupt the supply of power to the heater 18 and 24.

According to one embodiment, the controller 12 may control the supply of power to the heater 18 and 24 based on whether the cartridge has been coupled and/or removed. For example, upon determining that the cartridge has been removed using the cartridge detection sensor (e.g., the sensor unit 13), the controller 12 may interrupt the supply of power to the heater 18 or 24 or may perform control such that power is not supplied to the heater 18 and 24.

According to one embodiment, the controller 12 may control the supply of power to the heater 18 and 24 based on whether the aerosol-generating substance in the cartridge has been exhausted. For example, upon determining that the temperature of the heater 18 and 24 exceeds a limit temperature during preheating of the heater 18 and 24 (i.e., in the preheating section), the controller 12 may determine that the aerosol-generating substance in the cartridge has been exhausted. Upon determining that the aerosol-generating substance in the cartridge has been exhausted, the controller 12 may interrupt the supply of power to the heater 18 and 24.

According to one embodiment, the controller 12 may control the supply of power to the heater 18 and 24 based on whether use of the cartridge is possible. For example, upon determining, based on data stored in the memory 17, that the current number of puffs is equal to or greater than the maximum number of puffs set for the cartridge, the controller 12 may determine that use of the cartridge is impossible. Alternatively, when a total time period during which the heater 18 and 24 is heated is equal to or longer than a preset maximum time period or when the total amount of power supplied to the heater 18 and 24 is equal to or greater than a preset maximum amount of power, the controller 12 may determine that use of the cartridge is impossible. In this case, the controller 12 may interrupt the supply of power to the heater 18 or 24 or may perform control such that power is not supplied to the heater 18 and 24.

According to one embodiment, the controller 12 may control the supply of power to the heater 18 and 24 based on the user's puff. For example, the controller 12 may determine whether a puff occurs and/or the intensity of a puff using the puff sensor (e.g., the sensor unit 13). When the number of puffs reaches a preset maximum number of puffs and/or when no puff is detected for a preset time period or longer, the controller 12 may interrupt the supply of power to the heater 18 and 24. When a puff is detected, the controller 12 may control the supply of power to the heater 18 and 24.

According to one embodiment, the controller 12 may control the supply of power to the heater 18 and 24 based on whether the aerosol-generating article (or the cartridge) is authentic and/or the type of the aerosol-generating article (or the cartridge). For example, the controller 12 may determine whether the aerosol-generating article is authentic and/or may determine the type of the aerosol-generating article using the cigarette identification sensor (e.g., the sensor unit 13). In an example, upon determining that the aerosol-generating article (or the cartridge) is inauthentic, the controller 12 may interrupt the supply of power to the heater 18 and 24. Upon determining that the aerosol-generating article (or the cartridge) is authentic, the controller 12 may control (e.g., commence) the supply of power to the heater 18 and 24. In another example, the controller 12 may control the supply of power to the heater 18 and 24 differently depending on the type of the aerosol-generating article (or the cartridge). In more detail, upon determining that the aerosol-generating article (or the cartridge) is a first aerosol-generating article (or a first cartridge), the controller 12 may control the temperature of the heater 18 and 24 and/or power based on a first temperature profile (or a first power profile), and upon determining that the aerosol-generating article (or the cartridge) is a second aerosol-generating article (or a second cartridge), the controller 12 may control the temperature of the heater 18 and 24 and/or power based on a second temperature profile (or a second power profile).

According to one embodiment, the controller 12 may control the output unit 14 based on a result of detection by the sensor unit 13. For example, when the number of puffs counted using the puff sensor (e.g., the sensor unit 13) reaches a preset number, the controller 12 may control the output unit 14 to visually, haptically, and/or audibly provide information that operation of the aerosol-generating device 1 will end soon. For example, the controller 12 may control the output unit 14 to visually, haptically, and/or audibly provide information about the temperature of the heater 18 and 24.

According to one embodiment, based on occurrence of a predetermined event, the controller 12 may store a history of the corresponding event in the memory 17 and may update the history. For example, the event may include events performed in the aerosol-generating device 1, such as detection of insertion of the aerosol-generating article, commencement of heating of the aerosol-generating article, detection of puff, termination of puff, detection of overheating of the heater 18 and 24, detection of application of overvoltage to the heater 18 and 24, termination of heating of the aerosol-generating article, on/off operation of the aerosol-generating device 1, commencement of charging of the power supply 11, detection of overcharging of the power supply 11, and termination of charging of the power supply 11. For example, the history of the event may include the occurrence date and time of the event and log data corresponding to the event. For example, when the predetermined event is detection of insertion of the aerosol-generating article, the log data corresponding to the event may include data on a value detected by the insertion detection sensor (e.g., the sensor unit 13). For example, when the predetermined event is detection of overheating of the heater 18 and 24, the log data corresponding to the event may include data on the temperature of the heater 18 and 24, the voltage applied to the heater 18 and 24, and the current flowing through the heater 18 and 24.

According to one embodiment, the controller 12 may control the communication unit 16 to form a communication link with an external device such as a user's mobile terminal.

According to one embodiment, upon receiving data on authentication from an external device via the communication link, the controller 12 may release restriction on use of at least one function (e.g., a heating function) of the aerosol-generating device 1. For example, the data on authentication may include the user's birthday, an identification number uniquely identifying the user, and whether authentication is completed by the user.

According to one embodiment, the controller 12 may transmit data on the state of the aerosol-generating device 1 (e.g., remaining capacity of the power supply 11 and operation mode) to the external device via the communication link. The transmitted data may be output through a display or the like of the external device.

According to one embodiment, upon receiving a request to search for the location of the aerosol-generating device 1 from the external device via the communication link, the controller 12 may control the output unit 14 to perform an operation corresponding to location search. For example, the controller 12 may perform control such that the haptic unit generates vibration or the display outputs objects corresponding to location search and termination of search.

According to one embodiment, upon receiving firmware data from the external device via the communication link, the controller 12 may perform firmware update.

According to one embodiment, the controller 12 may transmit data on a value detected by the at least one sensor unit 13 to an external server (not shown) via the communication link, and may receive, from the server, and store a learning model generated by learning the detected value through machine learning such as deep learning. The controller 12 may perform the operation of determining the user's puff pattern and the operation of generating the temperature profile using the learning model received from the server.

Although not shown in FIG. 1, the aerosol-generating device 1 may further include a power supply protection circuit. The power supply protection circuit may include at least one switching element, and may block an electric path to the power supply 11 in response to overcharging and/or overdischarging of the power supply 11. The aerosol-generating device 1 may further include a connection interface such as a universal serial bus (USB) interface, and may be connected to other external devices through the connection interface to transmit and receive information or charge the power supply 11.

The aerosol-generating article mentioned in the present disclosure may include at least one aerosol-generating rod (e.g., a medium portion) and at least one filter rod. The heater 18 may be disposed to correspond to the at least one aerosol-generating rod, and may be designed differently depending on the arrangement order and/or positions of the aerosol-generating rod and the filter rod. The aerosol-generating rod may contain at least one of nicotine, an aerosol-generating substance, and an additive. For example, the aerosol-generating substance may include glycerin (e.g., vegetable glycerin (VG)) and/or propylene glycol (PG) and may also include various other substances. For example, the additive may include a flavoring agent and/or an organic acid and may also include various other substances. For example, the aerosol-generating rod may include an aerosol-generating substrate (e.g., a sheet) impregnated with a liquid non-tobacco substance (e.g., an aerosol-generating substance and/or nicotine) and/or may contain a solid tobacco substance (e.g., leaf tobacco and reconstituted tobacco). The tobacco substance may be contained in the aerosol-generating rod in various forms, such as shredded tobacco, granules, and powder. According to one embodiment, the additive of the aerosol-generating rod may include an alkaline substance. Based on the alkaline substance, nicotine contained in the tobacco substance in the aerosol-generating rod may have an alkaline pH (e.g., pH 7.0 or higher). In this case, freebase nicotine may be released from the aerosol-generating rod even at a low temperature. According to one embodiment, the aerosol-generating rod may include two or more aerosol-generating rods, each of which may contain a tobacco substance and/or a non-tobacco substance. Meanwhile, although not shown, the at least one aerosol-generating rod and the at least one filter rod may individually and/or integrally be wrapped by at least one wrapper. In the present disclosure, the aerosol-generating article may be referred to as a stick.

The cartridge mentioned in the present disclosure may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance. Meanwhile, the cartridge may include a storage part that contains the aerosol-generating substance and/or a liquid delivery part that is impregnated with (contains) the aerosol-generating substance. For example, the liquid delivery part may include a wick formed of, e.g., cotton fiber, ceramic fiber, glass fiber, or porous ceramic. The cartridge heater 24 may be included in the cartridge in a coil-shaped structure surrounding (or wound around) the liquid delivery part or a structure contacting one side of the liquid delivery part. Alternatively, the cartridge heater 24 may be included in the aerosol-generating device 1, which is removable from the cartridge.

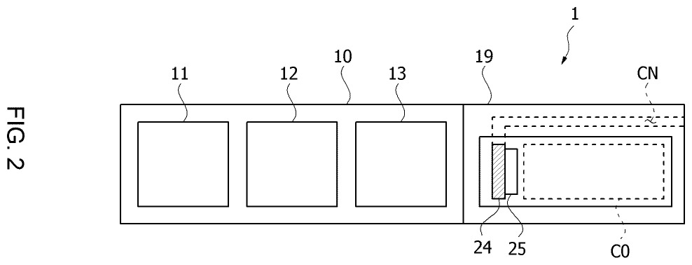

FIG. 2 shows an aerosol-generating device 1 according to an embodiment. According to one embodiment, the aerosol-generating device 1 may include a housing 10, a power supply 11, a controller 12, and/or a sensor unit 13. However, it will be understood by those skilled in the art related to the present embodiment that the components included in the aerosol-generating device 1 are not limited to those shown in FIG. 2 and that some of the components may be omitted or new components may be further included. In the drawings below, a description of configurations identical to those shown in FIG. 1 will be omitted.

According to one embodiment, the housing 10 may include a structure that allows a cartridge 19 to be inserted into or mounted on one side thereof. In this case, the cartridge 19 may be removably coupled to the housing 10.

Although not shown in the drawings, the housing 10 and/or the cartridge 19 may include a mouthpiece. A user may inhale an aerosol while holding the mouthpiece in the mouth.

According to one embodiment, the cartridge 19 may include a chamber C0 containing an aerosol-generating substance. The chamber C0 may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance.

According to one embodiment, a liquid delivery part 25 that is impregnated with (contains) the aerosol-generating substance may be included in the cartridge 19. For example, the liquid delivery part 25 may be impregnated with the aerosol-generating substance supplied from the chamber C0. Here, the liquid delivery part 25 may include a wick formed of, e.g., cotton fiber, ceramic fiber, glass fiber, or porous ceramic. Although not shown in the drawings, the aerosol-generating device 1 may further include a liquid delivery part. In this case, at least a portion of the first liquid delivery part of the cartridge 19 and at least a portion of the second liquid delivery part of the aerosol-generating device 1 may be formed in contact with each other. In this case, the first liquid delivery part and the second liquid delivery part may be implemented in different forms. For example, the first liquid delivery part may include cotton fiber, and the second liquid delivery part may include porous ceramic. Alternatively, the cartridge 19 may not include a liquid delivery part, and the aerosol-generating substance in the cartridge 19 may be delivered to the liquid delivery part of the aerosol-generating device 1.

According to one embodiment, the housing 10 and/or the cartridge 19 may be provided with an airflow channel through which air flows.

For example, the housing 10 may include a structure allowing outside air to be introduced into the housing 10 in the state in which the cartridge 19 is coupled thereto. In an example, an air inlet through which outside air may be introduced into the housing 10 may be formed in one side surface of the housing 10. The air inlet may also be formed in the lower end surface of the housing 10. Outside air introduced into the housing 10 through the air inlet may pass through the cartridge 19, and then may flow toward the user's oral cavity through the airflow channel CN. The outside air introduced through the air inlet may flow to the user's oral cavity through the airflow channel CN via the cartridge 19.

For example, the airflow channel CN may be included in the cartridge 19. The airflow channel CN may connect the chamber (e.g., an atomization chamber) in which the cartridge heater 24 or the liquid delivery part 25 is disposed to the outside of the housing 10 and/or the cartridge 19. In more detail, one end of the airflow channel CN may be open to the chamber (e.g., the atomization chamber) in which the cartridge heater 24 or the liquid delivery part 25 is disposed, and the other end thereof may communicate with the mouthpiece. The airflow channel CN may be elongated from one side of the chamber C0 of the cartridge 19 in the longitudinal direction of the cartridge 19. The airflow channel CN may also be elongated in the longitudinal direction of the cartridge 19 through the chamber C0 of the cartridge 19. The airflow channel CN may also communicate with a separate mouthpiece provided at the housing 10.

According to one embodiment, the cartridge heater 24 may heat the aerosol-generating substance contained in the cartridge 19. For example, the cartridge heater 24 may include an electro-resistive heater and/or an induction heater. In an example, the electro-resistive heater may include an electro-resistive material, and may generate heat as current flows through the electro-resistive material. In another example, in the case of an induction heater, the aerosol-generating device 1 may include an induction coil (not shown) provided around the induction heater. The induction heater may include a susceptor, and may generate heat based on a magnetic field generated by the induction coil (not shown). The cartridge heater 24 may be formed in a coil shape surrounding (or wound around) the liquid delivery part included in the cartridge 19 and/or the aerosol-generating device 1 and/or in a shape (e.g., a pattern shape) contacting one side of the liquid delivery part.

According to one embodiment, the cartridge heater 24 may be included in the cartridge 19. If the cartridge 19 is formed to be removable from the housing 10, the cartridge heater 24 may be removed from the aerosol-generating device 1 together with the cartridge 19. Unlike the configuration shown in the drawings, the cartridge heater 24 may be included in the aerosol-generating device 1. For example, the cartridge heater 24 may be included inside the housing 10. Meanwhile, the cartridge heater 24 may be included in a form that is removable from the housing 10 separately from (i.e., independently of) the cartridge 19. In other words, the cartridge heater 24 may or may not be removed from the housing 10 regardless of removal of the cartridge 19.

According to one embodiment, an aerosol may be generated based on generation of heat by the cartridge heater 24. As the liquid delivery part 25 is heated by the cartridge heater 24, an aerosol may be generated. For example, as the aerosol-generating substance impregnated in the liquid delivery part 25 is heated by the cartridge heater 24, vapor may be generated from the aerosol-generating substance, and an aerosol may be generated as the generated vapor is mixed with the outside air introduced into the cartridge 19. The aerosol generated by the cartridge heater 24 may be inhaled into the user's oral cavity through the airflow channel CN.

According to one embodiment, the cartridge 19 may be integrally formed with the aerosol-generating device 1 (e.g., the housing 10). The cartridge 19 may be formed so as not to be removed from the aerosol-generating device 1 by the user. Even in this case, the cartridge 19 and/or the aerosol-generating device 1 may include at least one liquid delivery part, and an aerosol may be generated based on heating of the liquid delivery part 25 by the cartridge heater 24 included in the aerosol-generating device 1 or the cartridge 19. The generated aerosol may be inhaled into the user's oral cavity through the airflow channel CN.

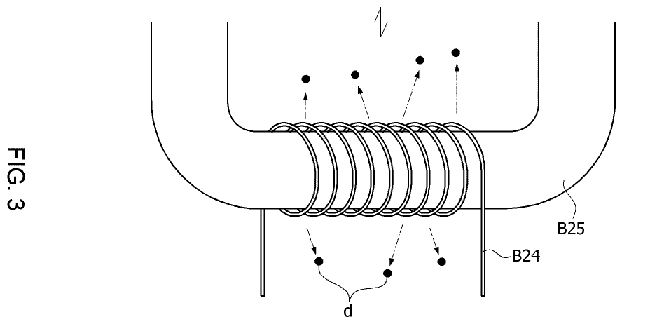

FIG. 3 is an exemplary view in which a spitback phenomenon occurs in a conventional liquid delivery means B25 and a heating element B24. The heating element B24 may be, for example, a cartridge heater 24. As the heating element B24 heats an aerosol-generating material impregnated in the liquid delivery means B25, bubbles are generated at the surface of the liquid delivery means B25, and a spitback phenomenon occurs in which the liquid covering the bubbles splashes in the form of droplets(d) due to the rise of the bubbles. This spitback phenomenon may cause a liquid overflow phenomenon in which liquid flows out, which may cause problems such as liquid leaking from the device or an unpleasant taste when inhaling an aerosol.

Although FIG. 3 illustrates an example in which the heating element B24 is in the form of a coil that surrounds the liquid delivery means B25, the same spitback phenomenon and liquid overflow phenomenon may occur even when the heating element B24 is bonded to a specific surface of the liquid delivery means B25.

In the following drawings, a liquid delivery means 25 and a heating element 24 according to various embodiments for preventing the above spitback phenomenon will be described.

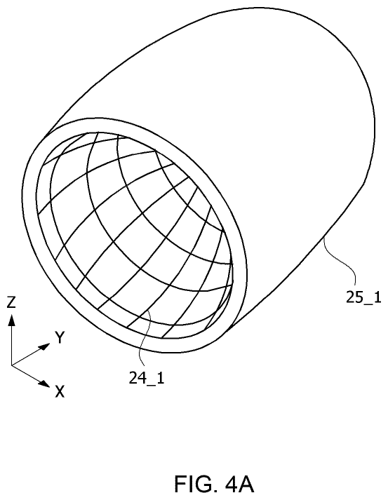

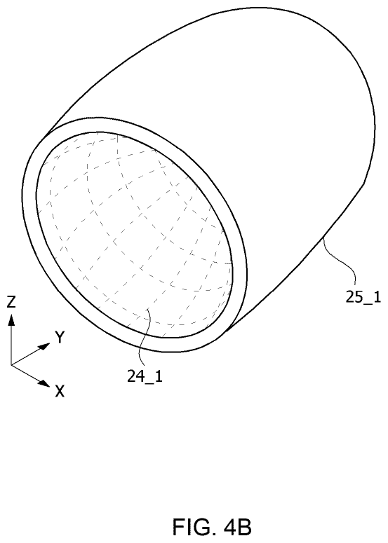

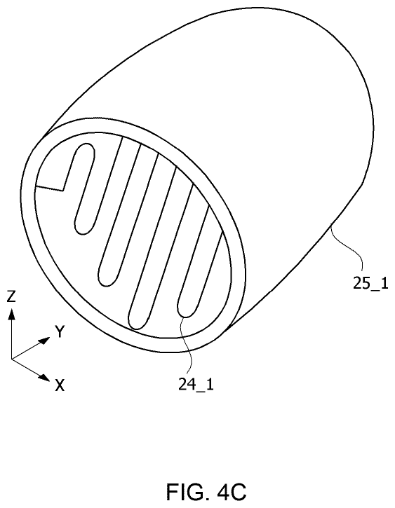

FIGS. 4A-4C are illustrative diagrams illustrating liquid delivery means and heaters in accordance with various embodiments.

Referring to FIG. 4A, a liquid delivery means 25_1 may be formed such that at least a part of space is recessed inward (+Y direction). A heating element 24_1 for heating an aerosol may be formed inside the liquid delivery means 25_1.

According to an embodiment, the heating element 24_1 may be formed in at least a part of the recessed area of the liquid delivery means 25_1. For example, the heating element 24_1 may be formed on at least a part of an inner peripheral surface or an inner surface of the liquid delivery means 25_1. For example, the heating element 24_1 may be formed to surround at least a part of the surface of the recessed area of the liquid delivery means 25_1.

The heating element 24_1 may be configured to include the heater 24 described above. For example, the heating element 24_1 may be implemented as a cartridge heater 24 for heating a cartridge (i.e., a solid and/or liquid medium). As another example, the heating element 24_1 may be a metallic object to which heat is conducted from the cartridge heater 24.

When the aerosol material is heated by the heating element 24_1 through the structure of the liquid delivery means 25_1 and the heating element 24_1 as shown in FIG. 4A, it is possible to minimize the phenomenon of splashing out of the liquid delivery means 25_1 because the droplets splash only in the internal space of the liquid delivery means 25_1. This makes it possible to prevent droplets from accumulating inside the cartridge 19.

In addition, the heating element 24_1 may be formed in a mesh pattern as shown in FIG. 4A. By being formed in a mesh pattern, the contact area where the heating element 24_1 and the liquid delivery means 25_1 come into contact with each other increases, and the heating efficiency increases.

Another embodiment of the liquid delivery means 25_1 and the heating element 24_1 is shown in FIG. 4B. FIG. 4B shows a form in which the heating element 24_1 is inserted to a predetermined depth toward the inside of the liquid delivery means 25_1.

That is, the heating element 24_1 may be inserted into the interior of the liquid delivery means 25_1 to a predetermined depth, based on at least a partial area of the recessed area of the liquid delivery means 25_1.

As the heating element 24_1 applies heat to the inside of the liquid delivery means 25_1 in such an inserted manner, the surface of the recessed area of the liquid delivery means 24_1 may also be heated relatively uniformly to minimize concentration of spitback in a specific area.

Another embodiment of the liquid delivery means 25_1 and the heating element 24_1 is shown in FIG. 4C. As shown in FIG. 4C, the heating element 24_1 may be formed in a jig-shaped pattern in consideration of the manufacturing cost and economic efficiency.

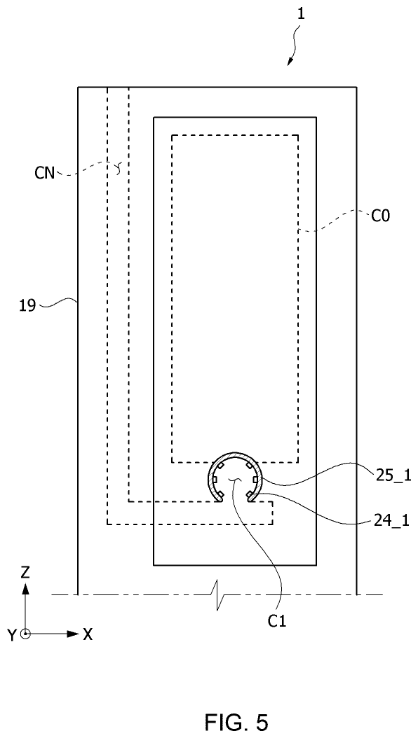

FIG. 5 is an exemplary view of a cartridge 19 including a liquid delivery means 25_1 and a heating element 24_1. In FIG. 5, for convenience of description, some configurations of the cartridge 19 and some configurations of an aerosol-generating device 10 coupled with the cartridge (19) are omitted forms, and the liquid delivery means 25_1 and the heating element 24_1 are shown in cross-sectional forms.

The chamber CO of the cartridge 19 contains an aerosol-generating material, and the liquid delivery means 25_1 may be located in a partial area of the chamber C0 to absorb the aerosol-generating material.

The heating element 24_1 heats at least a partial area of the liquid delivery means 25_1 to generate an aerosol, and the generated aerosol may be inhaled into the oral cavity of the user through an internal area C1 of the liquid delivery means 25_1 and an airflow channel CN. The airflow channel CN may be formed to communicate with the opening area of the cartridge 19 in the opened area of the chamber C0.

As shown in FIG. 5, the liquid delivery means 25_1 in which at least a part of the area to the space is recessed is included in the cartridge 19, so that most of the aerosol droplets generated by heating are splashed toward the inner area C1 of the liquid delivery means 25_1, and the discharge to the outside of the liquid delivery means 25_1 is minimized.

According to an embodiment, the liquid delivery means 25_1 may be formed such that the opened area faces the airflow channel CN. For example, as in FIG. 5, the liquid delivery means 25_1 may be formed such that an opened area with respect to the recessed inner area C1 faces the airflow channel CN (−Z direction).

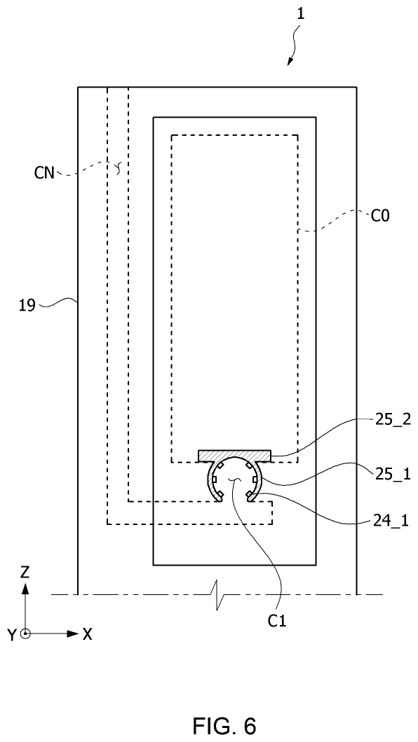

FIG. 6 shows a partial area of a cartridge 19 according to another embodiment.

According to an embodiment, the liquid delivery means 25_1 may further include a support 25_2. Since the liquid delivery means 25_1 in the embodiment of the present invention has a recessed area therein, at least a partial area of the liquid delivery means 25_1 may have a curved shape. In order to easily fix this liquid delivery means 25_1 in the curved form inside the cartridge 19, a support 25_2 may be included in the liquid delivery means 25_1. As a result, as shown in FIG. 6, the liquid delivery means 25_1 may be stably fixed in at least one area of the chamber C0.

On the other hand, in FIGS. 4 to 6, the liquid delivery means 25_1 and the heating element 24_1 are shown as being configured separately, but according to an embodiment, the heating element 24_1 may be implemented as at least a part of the liquid delivery means 25_1. For example, the liquid delivery means 25_1 may be formed of a metallic body. The liquid delivery means 25_1 may be heat conducted via any heating means and may heat the aerosol-generating material by itself with the conducted heat.

According to an embodiment, the liquid delivery means 25_1 and the heating element 24_1 may be configured as separate heater modules detachable from the cartridge 19 or the aerosol-generating device 1. In this case, a separate liquid delivery means distinct from the liquid delivery means 25_1 may be included inside the housing 10 of the aerosol-generating device 1. For example, as mentioned in FIG. 2, the liquid delivery means 25_1 of the heater module or the liquid delivery means 25_1 of the cartridge 19 may each be separately configured as a first liquid delivery means, and the liquid delivery means of the aerosol-generating device 1 as a second liquid delivery means. In this case, at least a part of the first liquid delivery means and at least part of the second liquid delivery means may be in contact with each other.

As such, the liquid delivery means 25_1 and the heating element 24_1 may be configured as separate detachable heater modules and may be detached from the cartridge 19, or may be configured in a form attached to the cartridge 19 so as not to be detached. The cartridge 19 may also be separated from the aerosol-generating device 1 or may be embodied in a non-separated form.

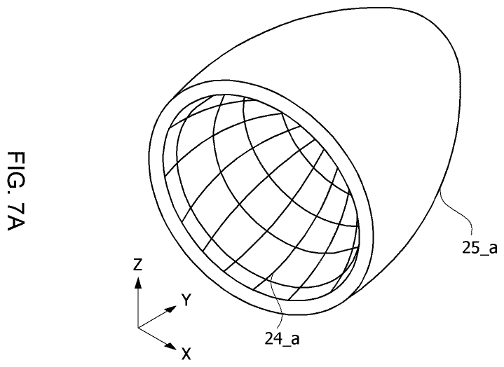

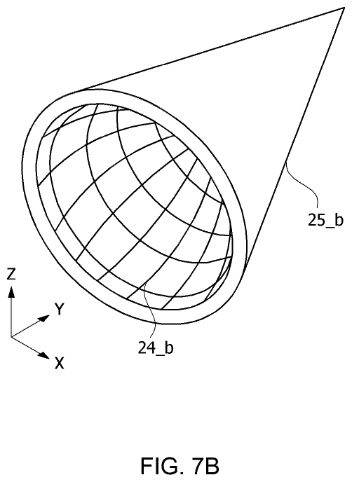

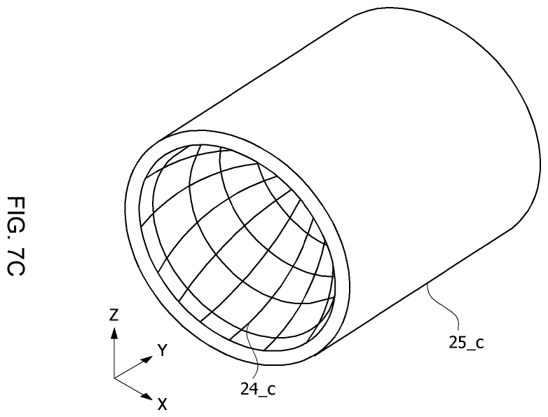

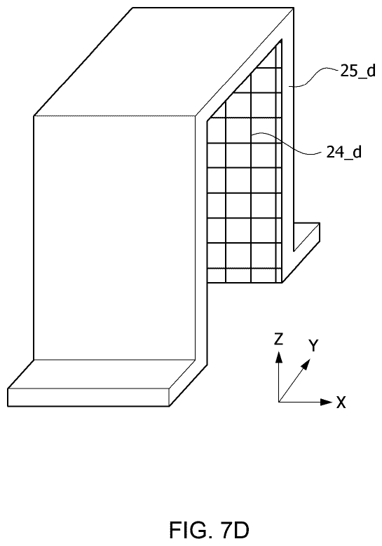

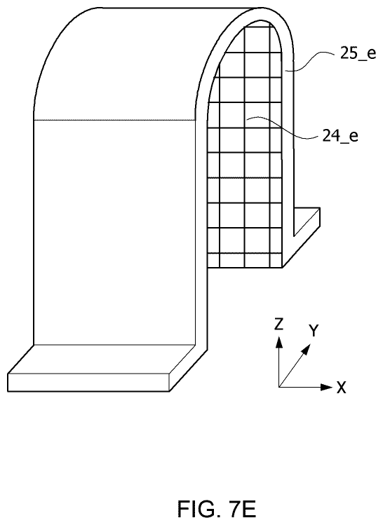

FIGS. 7A to 7E are diagrams illustrating a heating element 24_1 according to various embodiments.

As shown in FIGS. 7A to 7E, the heating element 24_1 may be formed of various types of heating elements 24_a, 24_b, 24_c, 24_d, 24_e in which at least some areas are recessed to generate a predetermined area inward. For example, the heating element 24_1 may be formed in various shapes such as a conical shape, a cylindrical shape, a bent shape, and a round shape having an empty space in the interior or at least in a partial area.

Further, various forms of liquid delivery means 25_a, 25_b, 25_c, 25_d, 25_e may be formed to surround or include the heating elements 24_a, 24_b, 24_c, 24_d, 24_e of FIGS. 7A-7E. The liquid delivery means 25_a, 25_b, 25_c, 25_d, 25_e may be formed in a form corresponding to each of the heating elements 24_a, 24_b, 24_c, 24_d, 24_e, and each of the heating element 24_a, 24_b, 24_c, 24_d, 24_e may be formed or bonded to at least a part of the recessed area of the liquid delivery means 25_1.

For example, the heating elements 24_a, 24_b, 24_c and the liquid delivery means 25_a, 25_b, 25_c of FIGS. 7A-7C may have areas that are recessed in the +Y direction. Further, the heating elements 24_d, 24_e and the liquid delivery means 25_d, 25_e of FIGS. 7D to 7E may have areas that are recessed in the +Z direction.

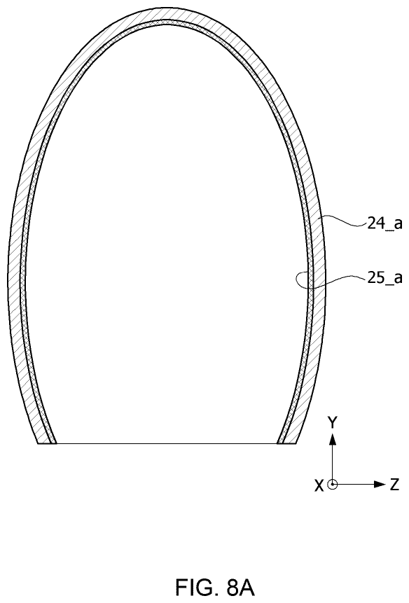

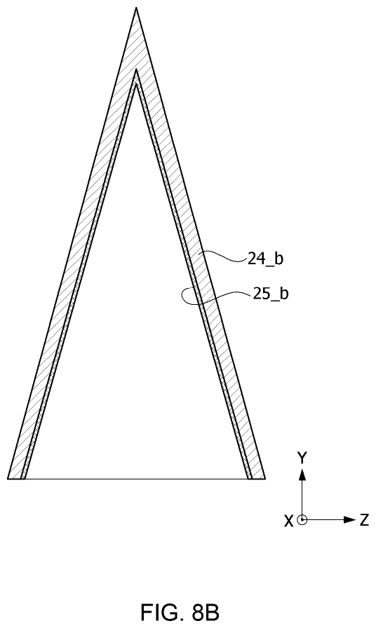

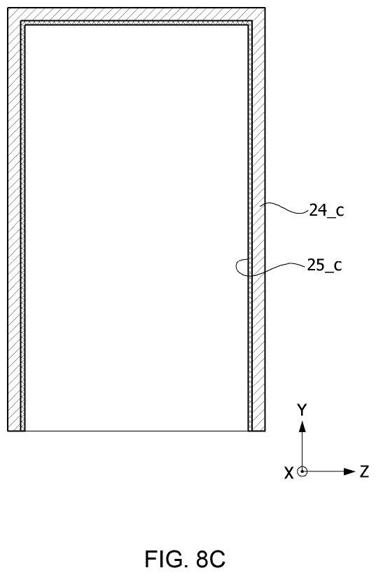

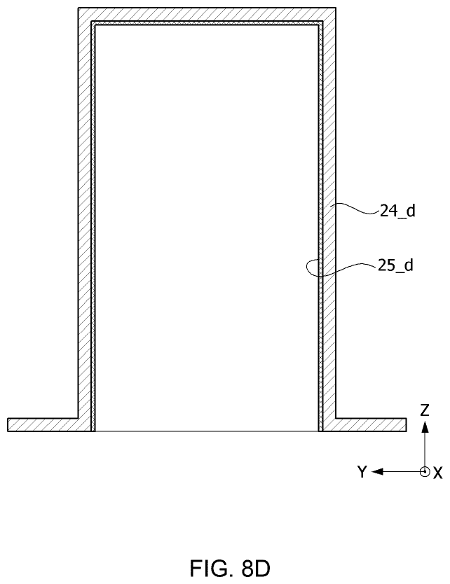

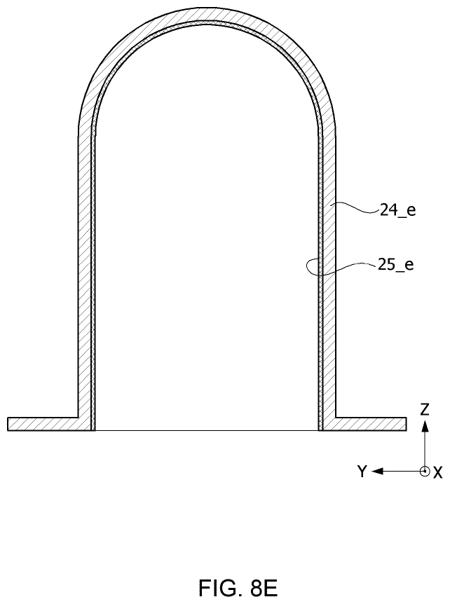

FIGS. 8A-8E illustrate cross-sections of a heating element according to various embodiments.

The heating elements 24_a, 24_b, 24_c, 24_d, 24_e and the liquid delivery means 25_a, 25_b, 25_c, 25_d, 25_e of FIGS. 8A to 8E show cross-sections of the heating elements 24_a, 24_b and 24_c and the liquid delivery means 25_a and 25_b and 25_c and 25_d and 25_e of FIGS. 7A to 7E.

In addition, in FIGS. 7A to 8E, the heating element 24_1 is illustrated as being located on the inner surface of the liquid delivery means 25_1, in contrast, the heating element 24_1 may also be implemented in a form in which the heating element 24_1 is inserted into the interior of the liquid delivery means 25_1 to a predetermined depth as in the embodiment of FIG. 4B.

With the liquid delivery means 25_1 and the heating element 24_1 disclosed in the foregoing drawings, it is possible to minimize the spitback phenomenon and liquid overflow phenomenon occurring in the cartridge 19 or the aerosol-generating device 1.

An aerosol-generating device 1 according to an embodiment may include: a housing 10; a chamber C0 including an aerosol-generating material; a liquid delivery means 25_1 configured to deliver the aerosol-generating material in an area adjacent to the chamber C0, wherein at least a part of the liquid delivery means is recessed therein; and a heating element 24_1 that heats the aerosol-generating material to generate an aerosol, wherein at least a part of the heating element 24_1 may be located in at least a part of a recessed area of the liquid delivery means.

In some embodiments, the heating element 24_1 may be formed to surround at least a part of the surface of the recessed area.

In some embodiments, the heating element may be inserted into the interior of the liquid delivery means to a predetermined depth based on at least a part of the recessed area.

In some embodiments, the heating element may be formed in a mesh pattern.

In some embodiments, the liquid delivery means 25_1 may be formed of a metallic body, and the heating element 24_1 may be implemented as at least a part of the liquid delivery means.

In some embodiments, the aerosol-generating device 1 may include an airflow channel CN communicating with an opening area of the housing in an opened area of the chamber C0, and the liquid delivery means 25_1 may be formed such that the opened area of the liquid delivery means 25_1 faces the airflow channel CN based on the recessed area of the liquid delivery means 25_1.

A cartridge that is detachable from an aerosol-generating device 1 may include: a chamber C0 including an aerosol-generating material; a liquid delivery means 25_1 configured to deliver the aerosol-generating material in an area adjacent to the chamber C0, wherein at least a part of the liquid delivery means is recessed therein; and a heating element 24_1 that heats the aerosol-generating material to generate an aerosol, wherein at least a part of the heating element 24_1 may be located in at least a part of a recessed area of the liquid delivery means 25_1.

In the cartridge 19 according to some embodiments, the heating element 24_1 may be formed to surround at least a part of the surface of the recessed area.

In the cartridge 19 according to some embodiments, the heating element 24_1 may be inserted into the interior of the liquid delivery means to a predetermined depth based on at least a partial area of the recessed area.

In the cartridge 19 according to some embodiments, the heating element 24_1 may be formed in a mesh pattern.

In the cartridge 19 according to some embodiments, the liquid delivery means 25_1 may be formed of a metallic body, and the heating element may be implemented as at least a part of the liquid delivery means.

A heater module according to an embodiment may include: a liquid delivery means 25_1 configured to absorb an aerosol-generating material, wherein at least a part of the liquid delivery means is recessed therein; and a heating element 24_1 that heats the aerosol-generating material to generate an aerosol, wherein at least a part of the heating element 24_1 may be located in at least a part of a recessed area of the liquid delivery means 25_1.

In the heater module according to some embodiments, the heating element 24_1 may be formed to surround at least a part of the surface of the recessed area.

In the heater module according to some embodiments, the heating element 24_1 may be inserted into the interior of the liquid delivery means 25_1 to a predetermined depth based on at least a partial area of the recessed area.

In the heater module according to some embodiments, the heating element 24_1 may be formed in a mesh pattern.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerosol-generating device, comprising:
a housing;
a chamber comprising an aerosol-generating material;
a liquid delivery means configured to deliver the aerosol-generating material in an area adjacent to the chamber, wherein at least a part of the liquid delivery means is recessed therein; and
a heating element that heats the aerosol-generating material to generate an aerosol,
wherein at least a part of the heating element is located in at least a part of a recessed area of the liquid delivery means.

2. The device of claim 1,
wherein the heating element is formed to surround at least a part of the surface of the recessed area.

3. The device of claim 1,
wherein the heating element is inserted into the interior of the liquid delivery means to a predetermined depth based on at least a partial area of the recessed area.

4. The device of claim 1,
wherein the heating element is formed in a mesh pattern.

5. The device of claim 1,
wherein the liquid delivery means is formed of a metallic body, and
the heating element is implemented as at least a part of the liquid delivery means.

6. The device of claim 1, further comprising:
an airflow channel communicating with an opening area of the housing in an opened area of the chamber, and
the liquid delivery means is formed such that the opened area of the liquid delivery means faces the airflow channel based on the recessed area of the liquid delivery means.

7. A cartridge that is detachable from an aerosol-generating device, comprising:
a chamber comprising an aerosol-generating material;
a liquid delivery means configured to deliver the aerosol-generating material in an area adjacent to the chamber, wherein at least a part of the liquid delivery means is recessed therein; and
a heating element that heats the aerosol-generating material to generate an aerosol,
wherein at least a part of the heating element is located in at least a part of a recessed area of the liquid delivery means.

8. The cartridge of claim 7,
wherein the heating element is formed to surround at least a part of the surface of the recessed area.

9. The cartridge of claim 7,
wherein the heating element is inserted into the interior of the liquid delivery means to a predetermined depth based on at least a partial area of the recessed area.

10. The cartridge of claim 7,
wherein the heating element is formed in a mesh pattern.

11. The cartridge of claim 7,
wherein the liquid delivery means is formed of a metallic body, and
the heating element is implemented as at least a part of the liquid delivery means.

12. A heater module that is detachable from an aerosol-generating device or a cartridge, comprising:
a liquid delivery means configured to absorb an aerosol-generating material, wherein at least a part of the liquid delivery means is recessed therein; and
a heating element that heats the aerosol-generating material to generate an aerosol,
wherein at least a part of the heating element is located in at least a part of a recessed area of the liquid delivery means.

13. The heater module of claim 12,
wherein the heating element is formed to surround at least a part of the surface of the recessed area.

14. The heater module of claim 12,
wherein the heating element is inserted into the interior of the liquid delivery means to a predetermined depth based on at least a partial area of the recessed area.

15. The heater module of claim 12,
wherein the heating element is formed in a mesh pattern.
